(19) United States
(12) Patent Application Publication
(10) Pub. No.: US 2013/0028658 A1
(43) Pub. Date: Jan. 31, 2013

(54) SPLICE SLEEVE WITH ELLIPTICAL OR COMPOUND CURVE CROSS SECTION

(71) Applicant: Alfred A. YEE, Honolulu, HI (US)

(72) Inventor: Alfred A. YEE, Honolulu, HI (US)

(21) Appl. No.: 13/191,922

(22) Filed: Jul. 27, 2011

(51) Int. Cl. F16B 7/00; B23P 25/00

(52) U.S. Cl. 403/270; 29/527.1

(57) ABSTRACT

A splice sleeve having an elliptical or compound curve cross section for connecting overlapping end portions of reinforcing bars utilized in various types of structures in which steel reinforcing bars are utilized and it is desired to connect the overlapping end portions of the reinforcing bars. The elliptical or compound curve cross section splice sleeve is configured to receive the overlapped end portions of the reinforcing bars and then be filled with hardenable material to resist axial tension and compression exerted on the reinforcing bars. In one embodiment, both ends of the sleeve are provided with an inwardly directed lip to increase the splicing capacity of the elliptical or compound curve cross section sleeve by increasing the resistance against radial outward forces imparted to the hardenable material when axial tension is exerted on the reinforcing bars, and also to serve as a guide to position the rebars to a minimum of about 3 mm from the inside wall surface of the sleeve.

### BACKGROUND OF THE INVENTION

1. Field of the Invention

The present invention generally relates to a splice sleeve tube device for joining the ends of at least two reinforcing bars utilized in various types of structures in which steel reinforcing bars are utilized, and it is desired to interconnect the overlapping end portions of such reinforcing bars. The splice sleeve tube device has an elliptical cross section or a curved cross section composed of curvatures of varying radii, referred to herein as a compound curve cross section, to receive and accommodate the end portions of the reinforcing bars in an overlapping relationship, with the splice sleeve being filled with hardenable material to resist axial tension or compression exerted on the reinforcing bars.

2. Description of the Related Art

The tube devices of the present invention serve the same purpose as my previous splice sleeves for reinforcing bars or rebar that are well known as exemplified in my prior U.S. Pat. No. 3,540,763 issued Nov. 17, 1970, for SPLICE SLEEVE FOR REINFORCING BARS. In this patent, the reinforcing bars connected by the sleeve and cementitious material are in axial alignment. Splice sleeves for connecting overlapping reinforcing bar end portions are also known, as exemplified in my prior U.S. Pat. No. 4,692,052 issued Sep. 8, 1987, for SPLICE SLEEVE FOR OVERLAPPING REINFORCING BARS. In this patent, the sleeve has a cylindrical cross section configuration.

### SUMMARY OF THE INVENTION

The present invention generally relates to a splice sleeve for joining at least two reinforcing bars or rebars used in various types of structures in which steel reinforcing bars are utilized and it is desired to connect the overlapping end portions of the reinforcing bars. As used herein, the terms “reinforcing bars” and “rebars” are used interchangeably and the term “compound curve” refers to curvatures of varying radii for the cross section of the splice sleeve tube device of the present invention.

The splice sleeve of the present invention has an elliptical cross section or one constructed in the form of compound curves and is configured to receive and accommodate the overlapped ends of the reinforcing bars along the radial axis having the greatest dimension. When the rebar ends are in place in the splice sleeve, the sleeve is then filled with hardenable material to resist axial tension or compression exerted on the reinforcing bars. The action of the sleeve is to hold the hardenable material in tight confinement against the surfaces of the overlapping reinforcing bar ends so that the surface deformation ridges of these bars will provide a tight gripping action with the confined hardenable material.

The hardenable material may contain an expansion agent which results in limited expansion of the grout mass that is firmly confined in the interior area of the tube sleeve. The inclusion of an expansion agent can induce tremendous internal pressures on the lapped ends of the rebars which greatly increases the bonding and strength of the connection.

The splice sleeve of the present invention is preferably provided with an inwardly directed lip at one or both ends. The lip reduces the inner diameter of the sleeve at the ends to provide added restraint against longitudinal shifting of the internal grout mass and therefore maximizing the confinement of the overlapping ends of the connected rebars. Another purpose of these lips is to serve as a guide to position the rebars to allow a gap of at least 3 mm between the outer rebar surface and the interior surface of the splice sleeve tube thus allowing the liquid hardenable grout to fill the gap and provide the necessary peripheral grout mass for confinement and frictional resistance of the rebars.

Accordingly, an object of the present invention is to provide a splice sleeve for interconnecting reinforcing bars in the form of a rigid sleeve having an elliptical or compound curve cross section in which the overlapping ends of the reinforcing bars are positioned in the sleeve. The space between the reinforcing bar ends and between the bars and the sleeve is filled with hardenable cementitious material such as grouting or the like so that the sleeve will restrain any radial displacement of the cementitious material thereby developing a confinement of the cementitious material and preventing it from outward movement thereby resulting in substantial “lock” between the surface deformation ridges of the rebars to provide significant resistance to axial tension and/or compression failure or displacement of the overlapped reinforcing bar ends.

Another object of the present invention is to provide a splice sleeve with an elliptical or compound curve cross section to allow sufficient tolerance and accommodation for overlapping reinforcing bars as set forth in the preceding object in which the elliptical or compound curve cross section splice sleeve has a first radial axis and a second radial axis that are generally perpendicular to each other with a first inner diameter of the elliptical or compound curve cross section sleeve as measured along the first radial axis (“the major axis”) being greater than a second inner diameter of the sleeve as measured along the second radial axis (“the minor axis”), perpendicular to the first radial axis, with the overlapping rebar ends being spaced from one another along the first radial, or major, axis.

A further object of the present invention is to provide a splice sleeve with an elliptical or compound curve cross section for overlapping reinforcing bars as set forth in the preceding objects in which one or both ends of the sleeve include an inwardly directed lip that provides added restraint against shifting of the internal grout mass and increases the splicing capacity of the overlapping sleeve arrangement as compared with cylindrical sleeve configurations. The inwardly directed lip at the ends of the sleeve also serves to position the rebar in a way to form a minimum gap of 3 mm between the rebar and the interior surface of the sleeve to ensure that a minimum thickness of the internal grout mass can be effectively formed completely around the perimeter of the rebar ends for the development of maximum bonding and shear resistance when restrained by the inwardly directed lip at each end of the sleeve.

A still further object of the present invention is to provide an elliptical or compound curve cross section splice sleeve for overlapping reinforcing bars which is simple in construction, easy to assemble and effective for securely restraining the overlapped ends of the reinforcing bars in connected relation in order to resist axial tension and/or compression exerted on the reinforcing bars.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a perspective view of a first cross section splice sleeve having an elliptical cross section in accordance with the present invention.

FIG. 2 is a vertical cross-sectional view of the sleeve shown in FIG. 1, with the ends of two reinforcing bars overlapping in an axial orientation and fixed with cementious medium that fills the sleeve.

FIG. 3 is a top view of the elliptical cross section splice sleeve shown in FIG. 1.

FIG. 4 is a cross-sectional view taken along line A-A of FIG. 3.

FIG. 5 is a cross-sectional view taken along line B-B of FIG. 3.

FIG. 6 is a cross-sectional view of a second splice sleeve having an elliptical cross section according to the present invention, showing cross sections of the overlapping rebar ends in place.

FIG. 7 is a cross-sectional view of a third splice sleeve having a compound curve cross section according to the present invention, and also showing cross sections of the overlapping rebar ends in place.

FIG. 8 is a cross-sectional view of a fourth splice sleeve having a compound curve cross section according to the present invention.

FIG. 9 is a graph of test results obtained when applying a load to rebar interconnected with an elliptical cross section splice sleeve according to the present invention, in which reinforcing bars having a diameter of 16 mm were joined in an overlapping fashion within the sleeve and the sleeve was filled with cementitious material.

FIG. 10 is a graph of test results obtained when applying a load to rebar interconnected with an elliptical splice sleeve according to the present invention in which reinforcing bars having a diameter of 20 mm were joined in an overlapping fashion within the sleeve and the sleeve was filled with cementitious material.

FIG. 11 is a graph of test results obtained when applying a load to rebar interconnected with an elliptical splice sleeve according to the present invention in which reinforcing bars having a diameter of 25 mm were joined in an overlapping fashion within the sleeve and the sleeve was filled with cementitious material.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

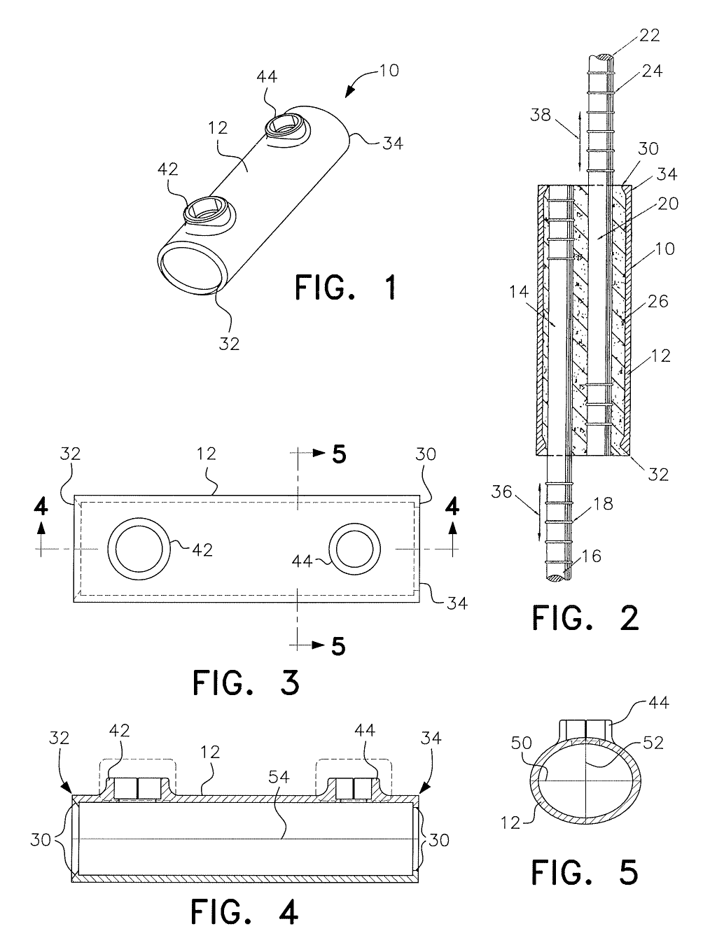

Referring now specifically to the drawings and FIG. 1 in particular, the splice sleeve of the present invention is generally designated by numeral 10 and includes a short section of rigid steel tubing or pipe forming a sleeve 12 of elliptical cross section configuration. When the sleeve is vertically oriented in use, as shown in FIG. 2, the sleeve 12 receives the upper end portion 14 of a lower reinforcing bar 16 having longitudinally spaced peripheral ribs or projections 18 thereon. The sleeve 12 also receives the lower end portion 20 of an upper reinforcing bar which also has longitudinally spaced peripheral ribs or projections 24 thereon. The reinforcing bars or rebar 16, 22 are conventional and normally employed in various types of structures utilizing concrete with reinforcing bars.

As illustrated in FIG. 2, the upper end portion 14 of the lower reinforcing bar 16 and the lower end portion 20 of the upper reinforcing bar 22 are received in the sleeve 12 in spaced and overlapping relation and the space between the portions 14 and 20 of the reinforcing bars and between the sleeve 12 and the reinforcing bars is filled with a cementitious material 26 in the form of grouting or the like which surrounds the rebar ends within the sleeve 10. The cementitious material has non-shrink and preferably slightly expansive properties.

As shown in FIGS. 2 and 4, the sleeve 12 is preferably provided with a lip 30 at both of its ends 32, 34. The lip 30 extends inwardly about 3 mm, although lip extensions of other sizes could be used as would be understood by persons of ordinary skill in the art. One purpose of the lip 30 is to retain the hardenable (cementitious) material from sliding outward and thus maintain its holding power and the strength of the connection. The lip also serves as a guide to position the outer surface of the rebars at a minimum gap of about 3 mm away from the inside wall surface of the splice sleeve. This minimum 3 mm spacing allows for flow of the hardenable material between the rebar surface and the interior surface of the elliptical or compound curve cross section sleeve, thus providing a peripheral grout mass around each overlapping rebar end that is restrained by the inwardly directed lip at each end of the sleeve. Providing a peripheral grout mass around each overlapping rebar end significantly increases the confinement of the hardenable material and bonding strength between the rebar and the sleeve.

The wall thickness of the sleeves is generally constant at about 4.5 mm as this is generally the thinnest casting wall thickness for practical production casting that will provide adequate stiffness for restraint and confinement of the grout mass. The wall thickness could vary, however, depending upon the specific application and/or developments in the art and the present invention is intended to include such variations.

When in a horizontal orientation as shown in FIGS. 1, 4 and 5, the elliptical or compound curve cross section splice sleeve according to the present invention has a major axis 50 and a minor axis 52 that are generally perpendicular to each other and to the longitudinal center axis 54 of the sleeve. A first inner diameter of the elliptical sleeve as measured along the major axis is greater than a second inner diameter of the elliptical sleeve as measured along the minor axis. Preferably, the ratio between the first and second inner diameters is in the range of about 1.47 to about 1.77, with an average ratio of approximately 1.686. A preferred ratio is approximately 1.73.

The elliptical or compound curve cross section shape of the splice sleeve according to the present invention has been shown to better accommodate the overlapped steel bars and increase ease in placement, while also providing greater coverage of concrete over the interior of the elliptical sleeve. The increased ease of placement during installation arises from having more internal tolerance to fit rebars, which naturally will allow thicker grout coverage within the sleeve. Preferably, the overlapping ends of the bars are positioned side by side within the sleeve along the major axis and spaced to be on either side of the longitudinal center axis of the sleeve. The ends can overlap to varying degrees, such as over 50% of the sleeve length, over 60% of the sleeve length, over 70% of the sleeve length, etc., but it is preferred that the rebar ends overlap along the entire length of the sleeve, i.e., the overlap length is made equal to the length of the sleeve for 100% overlap, as shown in FIG. 2. By overlapping the ends along the entire length of the sleeve, maximum parallel grout confinement is achieved and the strength of the splice is maximized.

According to a preferred embodiment, each bar is spaced from the longitudinal center axis closely equidistant (3 mm minimum) on each side of the center axis and a minimum of 3 mm from the inner side walls of the sleeve. However, other spacings and placements may be used while still obtaining acceptable improvements in tension and compression resistance from the elliptical or compound curve cross section sleeve.

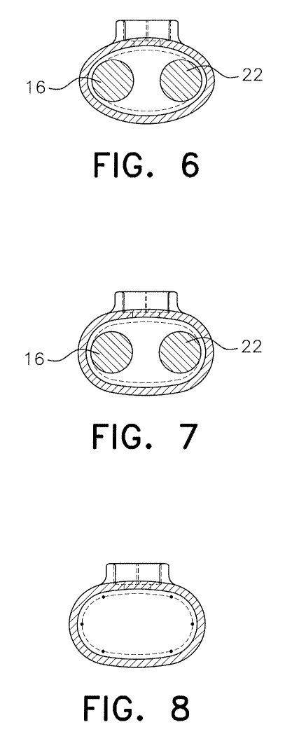

FIGS. 6-8 show additional representative sleeves according to the present invention. A sleeve having an elliptical cross section is shown in FIG. 6, while FIGS. 7 and 8 depict two possible compound curve cross section splice sleeves according to the present invention.

As shown in FIGS. 1, 3 and 4, the sleeve 12 includes holes or grout ports 42 and 44 in the wall thereof adjacent each end 32, 34 of the sleeve 12 through which cementitious material, grouting or the like is supplied into the interior of the sleeve to fill the interior and completely embed the overlapping ends of the reinforcing bars so that the deformations of the rebar surfaces and rings or projections 18 and 24 are intimately engaged and contacted by the cementitious material 26. When the cementitious medium hardens and axial tension or compression is exerted on the reinforcing bars 16 and 22, as illustrated by the force arrows 36, 38 in FIG. 2, the cementitious material will be confined within the sleeve with the sleeve imposing an opposite confining and restraining force in order to create a very secure frictional engagement between the reinforcing bars and cementitious medium. It is believed that the confinement action of the elliptical or compound curve cross section splice sleeve of the present invention serves to increase the splicing capacity of the overlapping steel rebar arrangement by as much as 500%, and even up to about 675%, when compared to lapped splices that are not confined in accordance with the present splice sleeve invention.

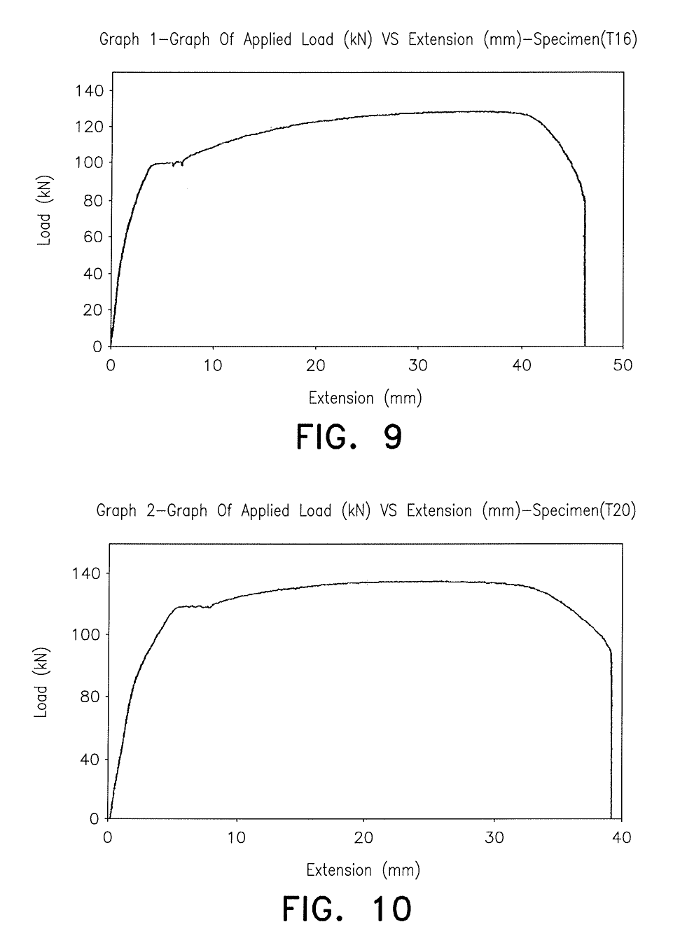

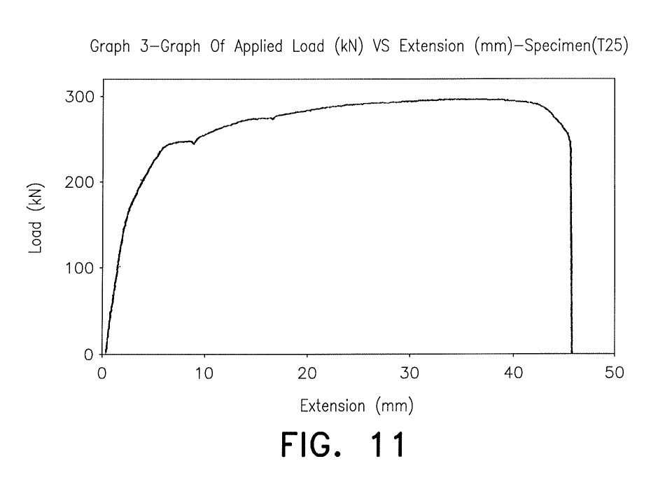

When subjected to actual load testing on three sizes of reinforcing steel bars fixed within the sleeve connector by hardened grout, the elliptical sleeve withstood the maximum load required, with all the steel bar samples fracturing rather than pulling out of the grouted sleeve connector. These tests were conducted with bar diameters of 16 mm (T16 rebar), 20 mm (T20 rebar), and 25 mm (T25 rebar). The parameters of the testing are summarized in Table I. In all cases, the bars fractured at points outside the sleeve while the connection of the bars made by the elliptical sleeve remained intact. These results are graphically illustrated in FIGS. 9-11.

TABLE T
Results:
Tension Load Test

| | Grout Spliced Reinforcement Steel Bars | | |
|---|---|---|---|
| | (Set B - AECS Sleeves) | | |
| Sample Reference | T16 | T20 | 725 |
| Nominal Size (mm) # | 16.0 | 20.0 | 25.0 |
| Nominal Cross-sectional area, | 201.06 | 314.16 | 490.87 |
| So (mm²) | | | |
| Maximum Load, P (kN) | 128.8 | 193.2 | 295.8 |
| $\frac{( P \times 1000 )}{So} ( N / {mm}^{2} )$ | 640.6 | 615.0 | 602.6 |

| | |
|---|---|
| Position of Fracture | Fractured at the reinforcement steel bar. |

‘#’ - Based on client's sample reference.

Specifically, FIG. 9 is a graph of test results obtained when applying a load to rebar interconnected with an elliptical cross section splice sleeve in which reinforcing bars having a diameter of 16 mm were joined in an overlapping fashion within the sleeve and the sleeve was filled with cementitious material. This test proved that the sleeve joining the two overlapping ends of 16 mm diameter rebars was strong enough to withstand a fracture load of the 16 mm diameter rebars.

FIG. 10 is a graph of test results obtained when applying a load to rebar interconnected with an elliptical splice sleeve in which reinforcing bars having a diameter of 20 mm were joined in an overlapping fashion within the sleeve and the sleeve was filled with cementitious material. This test proved that the sleeve joining the two overlapping ends of 20 mm diameter rebars was strong enough to withstand a fracture load of the 20 mm diameter rebars.

FIG. 11 is a graph of test results obtained when applying a load to rebar interconnected with an elliptical splice sleeve according to the present invention in which reinforcing bars having a diameter of 25 mm were joined in an overlapping fashion within the sleeve and the sleeve was filled with cementitious material. This test proved that the sleeve joining the two overlapping ends of 25 mm diameter rebars was strong enough to withstand a fracture load of the 25 mm diameter rebars.

The various embodiments may be oriented vertically, horizontally or inclined depending on the connections to be made between between the overlapping reinforcing bars. Hardenable material generally of a cementitious grouting material or a suitable epoxy material can also be used. In some uses, the hardenable material can be placed into the sleeve through the end thereof before inserting the second overlapping bar, thereby eliminating the grout port holes in the sleeve.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A splice sleeve comprising a rigid sleeve having an internal space with an elliptical or compound curve cross section configured to receive end portions of a pair of axially extending reinforcing bars that are disposed in said sleeve in overlapping relation and having one or more grout ports in said sleeve to inject cementitious material into the sleeve internal space for enclosing the overlapping ends of the reinforcing bars and filling the sleeve internal space, said reinforcing bars being radially spaced from one another and from an inner surface of said sleeve by said cementitious material, said sleeve having an internal cross-sectional configuration substantially larger than the combined cross sectional area of the overlapping ends of the reinforcing bars positioned within the sleeve, said elliptical or compound curve cross section having a first inner diameter measured across an interior of said sleeve, and a second inner diameter measured across the sleeve interior in a direction perpendicular to said first inner diameter, said first inner diameter being greater than said second inner diameter.

2. The splice sleeve as defined in claim 1 wherein both ends of the sleeve are provided with an inwardly directed lip that reduces both the first and second diameters at the sleeve ends.

3. The splice sleeve as defined in claim 2 wherein the lip extends inwardly at least about 3 mm.

4. The splice sleeve as defined in claim 1 wherein said first inner diameter is measured across a major axis of said sleeve and said second inner diameter is measured across a minor axis of said sleeve.

5. The splice sleeve as defined in claim 4 wherein said sleeve includes a pair of grout ports each adjacent a respective end of the sleeve for receiving tubes to supply cementitious material into the interior of the sleeve.

6. The splice sleeve as defined in claim 5 wherein said grout ports are generally aligned with the minor axis.

7. A splice sleeve assembly comprising a rigid sleeve, end portions of axially extending reinforcing bars being disposed in said sleeve in overlapping relation, and cementitious material enclosing the overlapping ends of the reinforcing bars and filling the transverse cross-sectional area of the sleeve for resisting forces perpendicular to the longitudinal axes of the reinforcing bars when axial tension or compression is exerted on the overlapping reinforcing bars thereby imposing an opposite force toward the overlapping ends of the reinforcing bars to confine the cementitious material and develop a secure frictional engagement between the reinforcing bars and the cementitious material, said reinforcing bars and an inner surface of said sleeve being separated by a longitudinally extending space that is filled with said cementitious material to keep the bars spaced away from said inner surface, said frictional engagement between the reinforcing bars and the cementitious material and said confinement of said cementitious material within the sleeve securely retaining the overlapping ends of the reinforcing bars in overlapped relation, said sleeve when oriented horizontally having an elliptical or compound curve cross section with a major axis and a minor axis, a first inner diameter of the elliptical or compound curve cross section sleeve as measured along the major axis being greater than a second inner diameter of the elliptical sleeve as measured along the minor axis, the overlapping ends of the reinforcing bars being positioned side by side within said elliptical or compound curve cross section sleeve along the major axis.

8. The splice sleeve assembly as defined in claim 7, wherein at least one end of said elliptical or compound curve cross section sleeve is provided with an inwardly directed lip that reduces both the first and second inner diameters at the sleeve end, said lip defining a width of said longitudinally extending space when said bars are inserted into the sleeve substantially parallel with the longitudinal axis of said sleeve.

9. The splice sleeve assembly as defined in claim 7, wherein both ends of said elliptical or compound curve cross section sleeve are respectively provided with an inwardly directed lip that reduces both the first and second inner diameters at both sleeve ends, said lip defining a width of said longitudinally extending space when said bars are inserted into the sleeve substantially parallel with the longitudinal axis of said sleeve.

10. In combination, a pair of axially extending reinforcing bars having peripheral projections thereon, said bars having overlapping ends disposed in adjacent, generally parallel spaced relation, a rigid splice sleeve for receiving said overlapping ends of the axially extending reinforcing bars therein, and hardened medium enclosing the overlapping ends of the reinforcing bars and filling the transverse cross-sectional area of the sleeve to effect a connection of said overlapping bar ends, said hardened medium resisting forces perpendicular to the longitudinal axes of the reinforcing bars when axial tension or compression is exerted on the overlapping ends of the reinforcing bars with the sleeve imposing inwardly directed force against the overlapping ends of the reinforcing bars to develop a secure frictional and confining engagement between the reinforcing bars and the hardened medium to securely retain the connection of the overlapping ends of the reinforcing bars in overlapped relation, said sleeve having an elliptical or compound curve cross section, at least one end of said elliptical or compound curve cross section sleeve having an inwardly directed lip that reduces an inner diameter of the sleeve to assist in containing the hardened medium within the sleeve.

11. The combination as defined in claim 10 wherein both ends of said elliptical or compound curve cross section sleeve are respectively provided with an inwardly directed lip that reduces an inner diameter of the sleeve at said ends, said lips spacing the ends of the reinforcing bars away from an inner surface of said sleeve, the spacing between the bars and the sleeve inner surface being filled with the hardened medium and increasing strength of the connection.

12. The combination as defined in claim 10 wherein said sleeve when oriented horizontally has an elliptical cross section with a major axis that is horizontal and a minor axis that is vertical, a first inner diameter of the elliptical sleeve as measured along the major axis being greater than a second inner diameter of the elliptical sleeve as measured along the minor axis, the overlapping ends of the reinforcing bars being positioned side by side within said elliptical or compound curve cross section sleeve along the major axis.

13. The combination as defined in claim 12, wherein both ends of said elliptical or compound curve cross section sleeve are respectively provided with an inwardly directed lip that reduces both the first and second inner diameters at both sleeve ends, said lips spacing the ends of the reinforcing bars away from an inner surface of said sleeve, the spacing between the bars and the sleeve inner surface being filled with hardened medium and increasing strength of the connection.

14. The combination as defined in claim 13, wherein each overlapping rebar end extends a full length of said sleeve and a width of the spacing between the bars and the sleeve inner surface is defined by an inward extension of the lips.

15. A method of interconnecting the end portions of a pair of axially extending reinforcing bars using a rigid splice sleeve having an elliptical or compound curve cross section configured to receive the end portions in overlapping relation and to be filled with cementitious material to enclose the overlapping ends of the reinforcing bars and fill the transverse cross-sectional area of the sleeve, said sleeve having an internal cross-sectional configuration substantially larger than the combined cross sectional area of the overlapping ends of the reinforcing bars positioned within the sleeve, said elliptical or compound curve cross section having a first inner diameter measured across an interior of said sleeve, and a second inner diameter measured across the sleeve interior in a direction perpendicular to said first inner diameter, said first inner diameter being greater than said second inner diameter, the method comprising:
providing a pair of reinforcing bars to be joined and a splice sleeve having an elliptical or compound curve cross section;
inserting one end of each reinforcing bar into a respective end of the splice sleeve to bring the ends of the two bars into an overlapping relationship within the splice sleeve; and
filling the splice sleeve with cementitious material.

16. The method as set forth in claim 15, wherein the step of inserting the bar ends includes overlapping the bar ends over a length that is between 50% and 80% of an overall length of the sleeve.

17. The method as set forth in claim 15, wherein the step of inserting the bar ends includes overlapping the bar ends over a length that is approximately equal to an overall length of the sleeve.

18. The method as set forth in claim 17, wherein the step of inserting the bar ends includes aligning the bar ends along a radial axis corresponding with said first inner diameter.

19. The method as set forth in claim 18, wherein said step of aligning the bar ends includes placing said bar ends to be at least about 3 mm from the interior of the sleeve along the radial axis.

20. The splice sleeve as defined in claim 3 wherein the end portions of the pair of axially extending reinforcing bars are disposed within and substantially parallel with an inner surface of said sleeve, the inward extension of the lip spacing the reinforcing bars away from said inner surface of the sleeve to define a longitudinally extending space between the inner surface of the sleeve and the reinforcing bars, said space being filled with said cementitious material to keep the bars spaced away from said sleeve inner surface.
